(19) United States
(12) Patent Application Publication
(10) Pub. No.: US 2002/0064414 A1
(43) Pub. Date: May 30, 2002

(54) Binder with hole punch

(75) Inventor: Jon R. Wyant, Centerville, OH (US)

Correspondence Address: THOMPSON HINE L.L.P., 2000 COURTHOUSE PLAZA , N.E., 10 WEST SECOND STREET, DAYTON, OH, 45402, US

(73) Assignee: wyant

(21) Appl. No.: 09/488,599

(22) Filed: Jan. 20, 2000

(51) Int. Cl. B42F 3/00

(52) U.S. Cl. 402/4

(57) ABSTRACT

A binder for receiving and retaining loose leaf papers comprising a cover, a binding mechanism coupled to the cover, and a hole punch coupled to the cover. The hole punch is configured to punch a set of holes in a sheet of paper such that the binding mechanism can be received through the set of holes to receive and retain the paper in the binder.

The present invention is directed to a binder for receiving loose papers, and more particularly, to a binder for receiving loose papers, the binder having a hole punch.

### BACKGROUND OF THE INVENTION

Binders are used by students and professionals to store loose leaf papers and other loose items. The binders typically include a binding mechanism, such as a conventional three ring binder, to bind the papers together. However, many papers, such as hand-outs, photocopies, large or irregular-sized papers, and the like do not have pre-punched holes. In these cases, holes must be punched in the papers using a hole punch mechanism before the papers can be received in the binder. However, a hole punch may not always be readily available, and it can be difficult to predict when a hole punch may be needed. Furthermore, standard hole punches can be quite bulky and heavy, and therefore inconvenient to carry. Accordingly, there is a need for a binder that can form holes into a paper such that the papers can be received in the binding mechanism of the binder.

### SUMMARY OF THE INVENTION

The present invention is a binder having a hole punch mechanism. The hole punch is preferably mounted to the cover of the binder, and is configured to punch holes in a piece of paper such that the punched paper can be received in the binding mechanism of the binder. The present invention eliminates the need to carry a separate hole punch, and ensures that a hole punch mechanism is available whenever unpunched papers are desired to be placed into the binder.

In one embodiment, the invention is a binder for receiving and retaining loose leaf papers comprising a cover, a binding mechanism coupled to the cover, and a hole punch coupled to the cover. The hole punch is configured to punch a set of holes in a sheet of paper such that the binding mechanism can be received through the set of holes to receive and retain the paper in the binder.

Other objects and advantages of the present invention will be apparent from the following description and the accompanying drawings.

### BRIEF DESCRIPTION OF THE DRAWINGS

FIG. 1 is a top view of the binder of the present invention, with the hole punch, receptacle and pencil sharpener in their closed positions; and

FIG. 2 is a top view of the binder of FIG. 1, with the hole punch, receptacle and pencil sharpener in their open positions.

### DETAILED DESCRIPTION

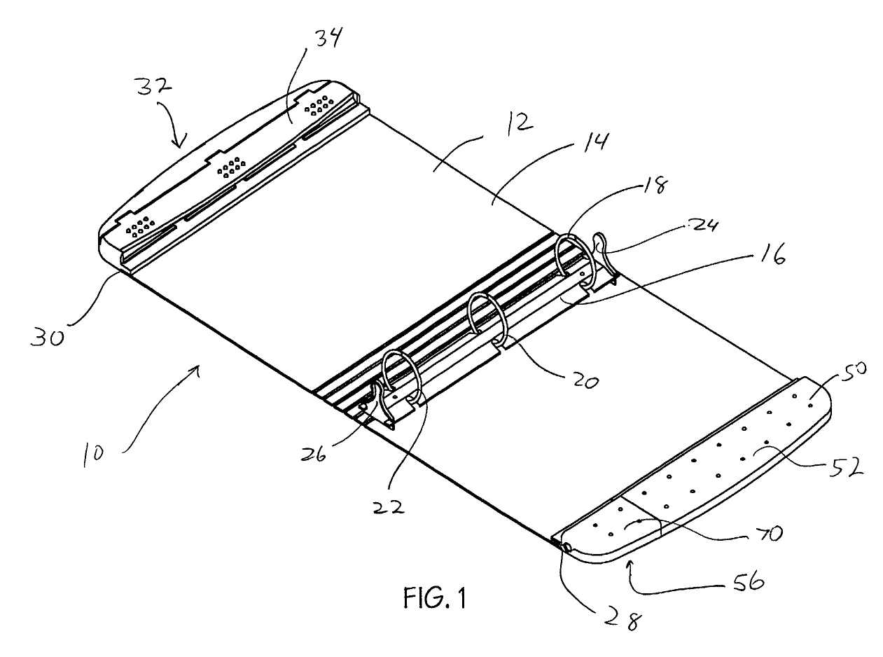

As shown in FIG. 1, the binder 10 of the present invention includes a cover 12 having an inner surface 14 and a binding mechanism 16 coupled to the inner surface of the cover. The binding mechanism 16 is shown as a conventional three ring binder, although a variety of binding mechanisms may be used without departing from the scope of the present invention. The illustrated binding mechanism 16 includes a set of openable rings 18, 20, 22 that are actuable by a set of triggers 24, 26. The rings 18, 20, 22 are preferably generally evenly spaced apart a distance of about 4¼ inches.

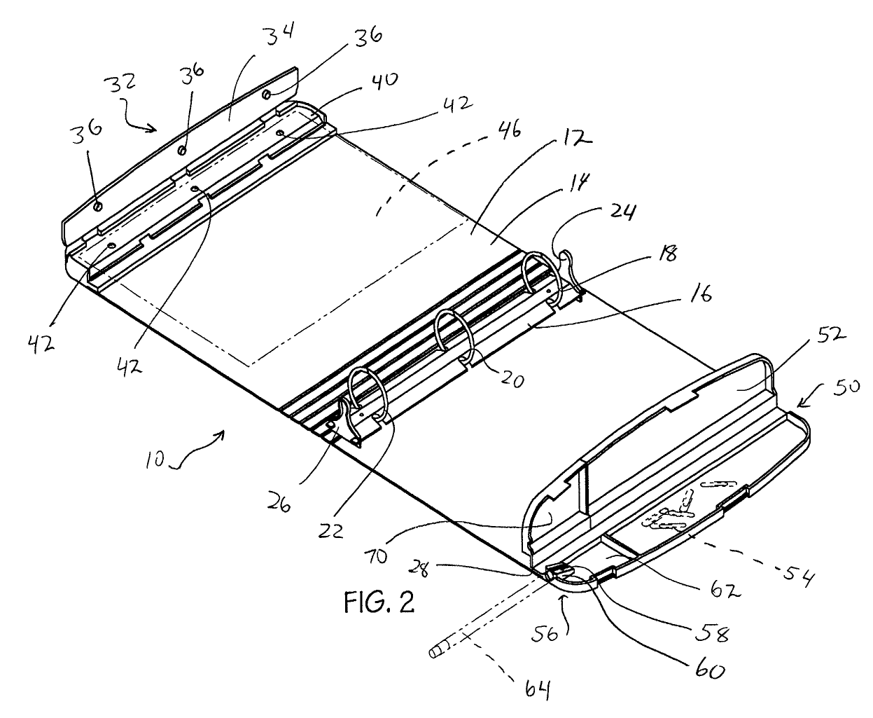

The cover 12 includes a pair of opposed outer edges 28, 30, and a hole punch 32 is located adjacent the outer edge 30. The hole punch 32 includes a movable handle 34 having a set of protrusions 36 on the lower surface of the handle 34 (FIG. 2). The hole punch 32 also includes a base 40 having a set of recesses 42 that are aligned with the protrusions 36. In order to punch a hole in a sheet of paper 46, the handle 34 is moved to its open position, as shown in FIG. 2. A paper 46 is then slid on top of the base 40 such that the paper is located between the handle 34 and the base 40. The handle 34 is then moved to the closed position such that the protrusions 36 are received in a respective recess 42, thereby punching a set of holes in the paper 46. The handle 34 and base 40 are preferably made of a light weight plastic material, such as acrylonitrile butadiene styrene (ABS) to provide a light weight hole punch 32.

The protrusions 36 and recesses 42 are preferably aligned such that the hole punch 32 forms a set of holes in the paper 46 that correspond to the spacing of the rings 18, 20, 22. In this manner, a sheet of paper punched with the hole punch 32 can be received in the binding mechanism 16. Of course, various other holes punches besides the hole punch 32 shown herein may be used without departing from the scope of the present invention. For example, the protrusions 36 may be located on the base 40 and the recesses 42 may be located on the handle 34. Furthermore, many other mechanisms beyond cooperating protrusions and recesses may be used as a hole punch mechanism. Preferably the hole punch 32 is configured to punch holes in a sheet of paper 46 such that the binding mechanism 16 can pass through the holes to receive and retain the paper in the binder 10. Further preferably the hole punch 32 forms the requisite holes in a single motion of the hole punch 32, such that multiple punchings of the paper 46 are not required.

The binder 10 further includes a receptacle 50 having a closable lid. The receptacle 50 can be used to hold various loose items (such as the paper clips 54 shown in FIG. 2) in a location that is convenient to the user. The binder 10 also has a pencil sharpener 56 located adjacent the receptacle 50. The pencil sharpener 56 includes a blade 58 mounted into a blade holder 60, and has a shavings receptacle 62 adjacent the blade holder 60 to receive the shavings generated by sharpening a pencil 64. The shavings receptacle 62 includes a closable lid 70 such that the shavings in the shaving receptacle 62 can periodically be emptied.

The pencil sharpener 56 and the receptacle 50 are located along the edge 28 of the cover 12. As shown in FIG. 1, when in the closed position the pencil sharpener 56 and receptacle 50 form a shape along the edge 28 that is similar to the shape of the hole punch 32 (in its closed position) along the edge 30. Furthermore, when the binder 10 is in a closed configuration, the handle 34 of the hole punch 32 engages lid 52 of the receptacle and the lid 70 of the pencil sharpener 56, which helps to maintain the alignment of, and prevent excess bending of, the cover 12 of the binder 10.

Having described the invention in detail and by reference to the preferred embodiments, it will be apparent that modifications and variations thereof are possible without departing from the scope of the invention.

What is claimed is:

1. A binder for receiving and retaining loose leaf papers comprising:
a cover;
a binding mechanism coupled to said cover; and
a hole punch coupled to said cover, said hole punch being configured to punch a set of holes in a sheet of paper such that said binding mechanism can be received through said set of holes to receive and retain said paper in said binder.

2. The binder of claim 1 wherein said binding mechanism includes a three binding rings having a predetermined spacing pattern, and wherein said hole punch is configured to form three holes in a sheet of paper having a spacing that corresponds to said predetermined spacing of said binding rings.

3. The binder of claim 2 wherein said hole punch is configured to from three holes in said sheet of paper, said three holes being generally uniformly spaced apart a distance of about 4¼ inches.

4. The binder of claim 2 wherein said hole punch can be operated in a single manual motion to punch holes in said sheet that correspond to said predetermined spacing pattern.

5. The binder of claim 1 wherein said cover includes a pair of opposed outer edges, and wherein said hole punch is located adjacent one of said outer edges.

6. The binder of claim 1 wherein said hole punch includes a movable handle having a set of protrusions, said hole punch further including a base having a set of recesses aligned with said protrusions such that when a sheet of paper is located between said handle and said base and said handle is moved to a punching position, each protrusion is received in a corresponding recess to punch a hole in said sheet.

7. The binder of claim 6 wherein said handle and said base are made of acrylonitrile butadiene styrene

8. The binder of claim 1 further comprising a pencil sharpener coupled to said cover.

9. The binder of claim 8 further comprising a receptacle having a closable lid coupled to said cover.

10. The binder of claim 9 wherein said cover includes an outer surface, an inner surface, and a pair of opposed outer edges, and wherein said hole punch is located on said inner surface adjacent one of said outer edges, and wherein said pencil sharpener and said receptacle are located on said inner surface adjacent the other outer edge.
